(19) United States
(12) Patent Application Publication
(10) Pub. No.: US 2022/0322860 A1
(43) Pub. Date: Oct. 13, 2022

(54) FLUID INTAKE MONITORING

(71) Applicant: Aquarate Limited, Liverpool, Merseyside (GB)

(72) Inventor: Rebecca Taylor, Liverpool (GB)

(21) Appl. No.: 17/629,702

(22) PCT Filed: Aug. 25, 2020
(86) PCT No.: PCT/EP2020/073736

§ 371 Date: Jan. 24, 2022

(30) Foreign Application Priority Data
Aug. 28, 2019 (GB) 1912312.4

(51) Int. Cl. A47G 23/16; G01F 23/263

(52) U.S. Cl. CPC A47G 23/16; G01F 23/265

(57) ABSTRACT

A cup for measuring the liquid intake of an individual. The cup comprising: a liquid holding portion, defined by at least one sidewall and a base; a liquid level sensor, comprising a plurality of conductive surfaces disposed in an array along the sidewall in a direction away from the base; and a processor, configured to derive a liquid level from the liquid level sensor by determining which of the plurality of conductive surfaces have a capacitance higher than a threshold value, the threshold value being indicative of the respective conductive surface being below a liquid level line, and thereby measure the liquid intake of the individual.

### FIELD OF THE INVENTION

The present invention relates to a cup for monitoring liquid intake, as well as a system suitable for, and a method of, monitoring an individual's liquid intake.

### BACKGROUND

Approximately 60% of body weight in males constitutes total body fluid, with 52% in females. A reduction in body fluids can have major effects on the body. Fluid balance can alter with disease and illness, and must be carefully monitored. Currently, user's liquid intake and output are recorded manually on a fluid balance chart. This method is time consuming and prone to measuring errors and inconsistency. Further, conventional fluid balance monitoring methods can lead to a number of difficulties. Conventional fluid balance monitoring methods often do not accurately portray a full picture of the individual's fluid balance, due to data being inaccurately recorded, or missed from the data set. Furthermore, the process of manually recording fluid balance is costly for healthcare providers and time-consuming for medical professionals. The results are important for healthcare decisions. An example of a neutral fluid balance is provided in table 1 below:

TABLE 1

| Inputs | Outputs |
|---|---|
| Metabolic water +200 mL | Faeces −200 mL |
| Food +700 mL | Expired air −300 mL |
| Drink +1,600 mL | Cutaneous transpiration −400 mL |
| | sweat −100 mL |
| | Urine −1,500 mL |
| TOTAL: +2,500 mL | TOTAL: −2,500 mL |

If the patient were to output more 50 mL fluid than they have inputted during a day, their fluid balance would be negative 50. If the opposite were true, then their fluid balance would be positive 50.

Oral consumption of liquids tend to account for a large portion of the average patients' daily liquid input, and urine tends to account for a large percentage of an average patients' outputs. However, these metrics can be hard to accurately measure due to a number of factors—for drinks; patients tend to consume a variety of drinks in a variety of beakers, and for urine; how much urine was passed tends to be guesswork.

The vast majority of hospital wards also tend to have many patients per nurse recording fluid balance data, this makes it easy for nurses to miss input/output activity of individual patients, which in turn will lead to an inaccurate Fluid Balance being recorded. As Fluid Balance is used to influence healthcare decisions, this level of inaccuracy is unacceptable.

However, present hydration monitoring devices are expensive and complicated to manufacture and can be severely inaccurate.

International Patent Application WO2017156459A1, proposes a container comprising a pair of capacitive sensors wrapped around the container in a helical arrangement to allow measurement of the liquid in the container regardless of the orientation of the container. Such arrangement of the capacitive sensors complicates manufacturing process. Furthermore, the disadvantage of this invention is that the container can only measure volume of water without a step of calibrating the container, and it requires the use of look up tables, such as artificial neural network (ANN), to determine the level of water. These methods require that the container be “trained” about a liquid before that liquid can be used inside the container, meaning new or unpopular liquids will not be compatible.

Another liquid sensing technology uses infrared LEDs and photosensitive diodes to identify liquid and track liquid consumption. US20160286993 proposes using LEDs to provide a low resolution for liquid level measurements as each LED takes up a relative large amount of space. This discrete sample space allows for large variations in the liquid volume without changes in the output from the container. Furthermore, LEDs and photosensitive diodes are expensive to manufacture as fabrication of LEDs is a complex high-temperature process.

Another liquid sensing technology uses two capacitive strips extending up sides of a beverage container. The capacitance is measured from a reference strip to calibrate the device when empty. When liquid is present, a measurement strip takes a capacitance measurement which can be converted into a liquid level measurement. However, such sensors can be very imprecise. For example, if a warm or hot liquid is dispensed, condensation within the cup causes erroneous measurements of liquid level and therefore incorrect or very imprecise measurements of liquid intake.

Accordingly, there is a need for liquid intake measurement solution that can precisely, continuously and conveniently track liquid intake for users over a period of time that is low cost and easy to manufacture.

### SUMMARY

In a first aspect, the invention provides a cup for measuring the liquid intake of an individual, the cup comprising:
a liquid holding portion, defined by at least one sidewall and a base;
a liquid level sensor, comprising a plurality of conductive surfaces disposed in an array along the sidewall in a direction away from the base; and
a processor, configured to derive a liquid level from the liquid level sensor by determining which of the plurality of conductive surfaces have a capacitance higher than a threshold value, the threshold value being indicating of the respective conductive surface being below a liquid level line, and thereby measure the liquid intake of the individual.

Advantageously, such a cup is operable to sense the liquid level of liquid retainable in the liquid holding portion with greater precision.

Optional features of this aspect will now be set out. These are applicable singly or, where applicable, in any combination with any aspect of the invention.

Herein, cup is to be understood as a container for drinking from. Mug and cup are considered synonymous, and the container may or may not have a handle.

The cup may have a cylindrical axis, and the array of conductive surfaces may extend in a direction parallel or substantially parallel to the cylindrical axis. The base of the liquid holding portion may form the base of the cylinder forming the cup, and the sidewall may form the curved circumference of the cylinder. Each conductive surface of the array may project in a direction perpendicular or substantially perpendicular to the cylindrical axis. The conductive surfaces may be or may function as capacitive sensors.

The cup may include one or more capacitive shields, positioned on an opposing side of the liquid level sensor to the liquid holding portion. The one or more shields can be used to negate the effect a user's hand may have on the conductive surfaces.

The cup may include a battery and wireless charger, and the liquid level sensor, processor, battery, and wireless charger may be within a sealed unit. Advantageously, this can allow the cup to be machine washed at high temperatures. This increases the suitability of the cup to be used in a clinical setting, where sanitation is important.

The cup may include an accelerometer, configured to detect movement of the cup, and the processor may be configured to derive a liquid level upon cessation of movement of the cup and compare this measurement to a previously made measurement. Accordingly, the measured liquid intake of the individual can be made more precise as errors due to the liquid in the cup moving relative to the conductive surfaces can be negated.

The cup may include a gyroscope, configured to detect angular motion of the cup, and the processor may be configured to prohibit the derivation of a liquid level whilst the cup is not substantially level. In some examples, the processor may be configured to prohibit the derivation of a liquid level if the cup is at an angle greater than 35° from vertical. Accordingly, the measured liquid intake of the individual can be made more precise as errors due to the liquid level in the cup not being aligned with the conductive surfaces can be negated. Moreover, the gyroscope and accelerometer can be used in combination to detect a spill event i.e. liquid lost from the cup which has not been consumed by the user. Further, in some examples, the processor may be configured to place the cup into a hibernation mode when readings from the gyroscope determine that the cup has been inverted. For example, the processor may determine, via the gyroscope, if the cup has been left inverted (i.e. upside down, with the base being furthest from the surface the cup is resting on) for a predetermined period of time (e.g. 7 seconds), in response to this determination the processor may enter a sleep or hibernation mode (i.e. a low power consumption mode, in which derivation of the liquid level is prohibited). The hibernation mode may also cause a wireless communication module, within the cup, to switch off and/or to be disabled and not broadcast. Advantageously, this can further lower the power consumption of the cup whilst the cup is not in use. In some embodiments, the wireless communication module may be switched back on only when the liquid level sensor detects a liquid within the liquid holding portion. Conveniently, this can allow the cup to be shipped with the wireless communication module switched off or disabled and to allow the enabling of the wireless communication module only when the cup contains liquid and is to be used. This is particularly advantageous in embodiments where the cup is an enclosed system (e.g. sealed to the IP67 standard), as a better seal can be achieved because no physical buttons or switches are required to enable the wireless communication module after shipping.

The liquid level sensor may include a common electrode, connected in parallel to each of the conductive surfaces. This common electrode can increase the range of capacitance readings available, thereby providing greater certainty that a given conductive surface is or is not submerged in liquid. The common electrode may be located in the base of the liquid holding portion.

Each conductive surface in the array may have substantially identical dimensions. This can simplify processing, as only a single threshold value would need to be stored by the processor for identifying whether a given conductive surface is or is not submerged in liquid. Alternatively, some of the conductive surfaces in the array may have different dimensions to other conductive surfaces in the array. In such an example, the processor may store a threshold value for each of the different geometries. The dimensions of each of the conductive surfaces in the array may be chosen based on their position within the cup.

The array of conductive surfaces may be spaced by non-identical spacing sizes. That is, different spacing may be used for the conductive surfaces along the array. This can reduces measurements errors in examples where the sidewall and base define a non-cylindrical liquid holding portion.

The array may have at least 10 conductive surfaces. Preferably, the array has at least 17 conductive surfaces. Increasing the number of conductive surfaces generally increases the resolution with which liquid intake can be measured.

The cup may include a temperature sensor, configured to measure the temperature of a liquid when present in the liquid holding portion. The processor may be configured to measure the temperature of a liquid when it is introduced to the liquid holding portion, and trigger an alert if the temperature exceeds a safety threshold (e.g. greater than 100° C.).

The processor may be configured to use a capacitance value from one or more of the conductive surfaces and a temperature value measured by the temperature sensor to identify a liquid present in the liquid holding portion.

The cup may further include a wireless communication module, and the processor may be configured to use the wireless communication module to determine a nearest individual identification unit, and to associate the measured liquid intake with the individual corresponding to the nearest individual identification unit. Advantageously, this means that's cups do not need to be allocated to specific individuals. As the cup is capable of determining who is presently using it. The processor may be further configured to reset a cumulative measure of fluid consumed if a new individual identification unit is determined to be the nearest. The processor may be configured to reset a cumulative measure of fluid consumed if the cumulative measure reaches a predetermined maximum. This can improve the detection of missed packets of data. The processor may be further configured to identify a specific, predetermined, individual identification unit and in response to identifying this as the closest individual identification unit, to change into a non-reporting mode. For example, staff of a hospital ward may pick up the cup for washing or storage, which will cause the cup to change into a non-reporting mode.

The cup may further include a wireless communication module, and may be configured to transmit the measurement liquid intake of the individual to a base station. The wireless communication module may be further configured to transmit any one or more of: an identification of the cup; an identification of the user; a current liquid level; an indication that a spill event has occurred; a cumulative total of liquid consumption for the user presently using the cup; a battery level; and a battery charge status.

If the processor detects a spill event has occurred, it may be configured to derive a new liquid level measure and to discount the change in liquid level when determining the cumulative total of liquid consumption for the user of the cup.

The processor may be configured to derive and store a cumulative total of liquid consumption for the user of the cup. This total may be reset, either after a given period (e.g. 24 hours) or in response to a reset command.

In a second aspect, the invention provides a system for monitoring the liquid intake of an individual, the system comprising:
a cup according to the first aspect, the cup including a wireless communication module and being configured to measure the liquid intake of the individual;
an individual identification unit, configured to wirelessly transmit an individual identification signal to the cup; and
a management computer, configured to receive and record the measured liquid level intake and the individual identification signal.

The individual identification unit may be an individual identification wristband.

The system may include one or more gateway devices, each configured to receive the measured liquid level intake and individual identification signal from one or more cups and to forward these to the management computer. The management computer may be configured to perform a deduplication process on measured liquid level intakes and individual identification signals received from two or more gateway devices. The gateway devices may be configured to use Bluetooth® to communicate with the one or more cups. The gateway devices can be dispersed around a site (e.g. hospital, hospital ward, residential home, etc.) in order to provide complete coverage.

The management computer may be configured to receive and record the measured liquid intake and individual identification signal received from the cup. The management computer may be configured to receive other data indicative of fluid intake or output of the individual. For example, the management computer may receive data indicative of fluid provided intravenously to the patient, or lost due to vomiting or urine output.

In a third aspect, the invention provides a method of monitoring the liquid intake of an individual using the cup of the first aspect.

### BRIEF DESCRIPTION OF THE DRAWINGS

Embodiments of the invention will now be described by way of example with reference to the accompanying drawings in which:

FIG. 1A is a perspective view of a lid for a cup according to the present invention;

FIG. 1B is a perspective view of a central body for a cup according to the present invention;

FIG. 1C is a perspective view of an electronics package for a cup according to the present invention;

FIG. 1D is a perspective view of a base for a cup according to the present invention;

FIG. 2 is an exploded perspective view of the electronics package of FIG. 1C;

FIGS. 3A and 3B are front and back views, respectively, of the liquid level sensor;

FIG. 4 is a system according to the present invention;

FIG. 5 is a schematic view of indicating components of the electronics package of FIG. 1C; and

FIG. 6 is a flowchart illustrating a method according to the present invention.

### DETAILED DESCRIPTION AND FURTHER OPTIONAL FEATURES

Aspects and embodiments of the present invention will now be discussed with reference to the accompanying figures. Further aspects and embodiments will be apparent to those skilled in the art. All documents mentioned in this text are incorporated herein by reference

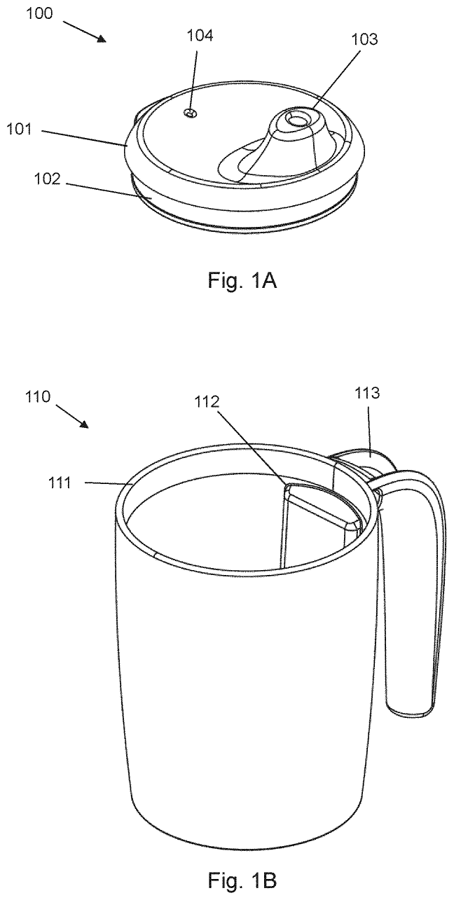

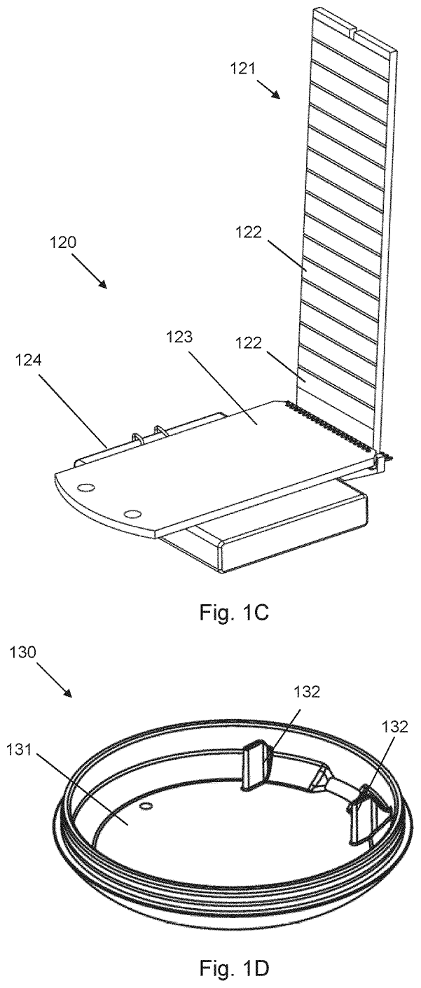

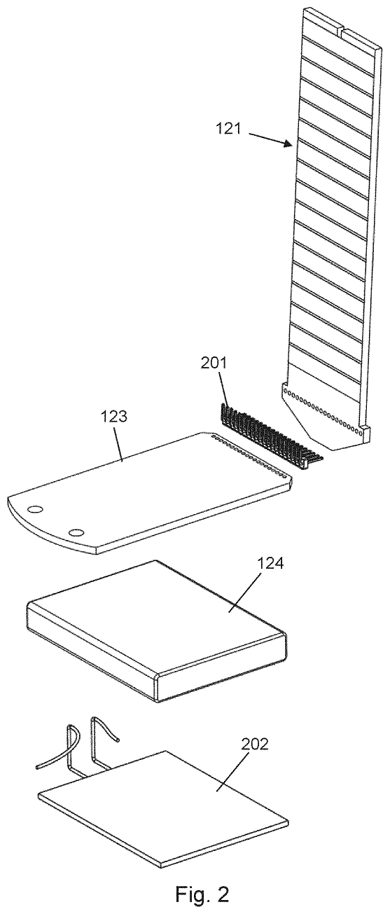

FIGS. 1A-1D show perspective views of various components for a cup according to the present invention. FIG. 1A shows a lid 100, including an upper housing 101 which can be fitted via lid connector 102 to a central body of the cup. The upper housing 101 also includes a mouthpiece 103 which may include a one-way valve (to minimise the risk of spills). Integrated into a portion of the upper housing is a vent hole 104, to ensure that the pressure within the cup is equalised. A light emitting diode (LED), not shown in this figure, which serves to provide notifications to a user or staff is also provided in the cup. For example, the LED may turn a predefined colour to indicate that the battery is low, or that the liquid in the cup is too hot. In one example, the LED may indicate (e.g. through a sequence of flashes, or a predefined colour) that the processor is attempting to take a liquid level reading but that the cup has not been placed on a level surface.

The lid 100 attaches to the central body 110 shown in FIG. 1B. The central body provides a sidewall 111 of the cup, in this case a cylinder. In this example, the central body 110 also includes a bed (not shown), connected to the sidewall so as to define a liquid holding portion of the cup. In other examples, the bed is provided as a distinct component which attaches to the sidewall. Inside of the space defined by the sidewall, i.e. on a radially inner side of the sidewall, is sensor housing 112. The sensor housing provides a seal between the liquid holding portion and a void within the housing, for containing the sensor. The central body 110 also includes a handle 113.

FIG. 1C shows electronics package 120, which includes: liquid level sensor 121, circuit board 123, battery 124, and wireless charging loop (not shown). The liquid level sensor and circuit board are, in this example, both rigid circuit boards. The liquid level sensor 121 includes a plurality of conductive surfaces 122, which form an array extending away from the circuit board 123. The conductive surfaces are separated by a dielectric layer. When installed within the sensor housing 112, the liquid level sensor extends up a wall of the liquid holding portion whilst being fluidly isolated therefrom. The circuit board 123 includes the LED mentioned previously, and the base or sidewall of the cup proximal to the LED is thinned relative to the other regions of the base or sidewall such that light from the LED can be seen.

The electronics package 120 sits below the bed of the central body 110 and so is fluidly isolated from the liquid holding portion defined by the bed and sidewall 111. Base 130 attaches to a lower portion of the central body 110, and encapsulates the electronics package 120. The base includes a lower housing portion 131, which defines the portion of cup which will be in contact with a surface once it has been set down. The base also includes liquid sensor guides 132, which provide an alignment feature in the base to ensure that the liquid level sensor is provided within the sensor housing 112. The base 130 attaches to the central body, in this example, through a push-fit type arrangement.

FIG. 2 shows an exploded perspective view of the electronics package of FIG. 1C. The electronics package includes: liquid level sensor 121, circuit board 123, battery 124, and wireless charging loop 202. The liquid level sensor is connected to the circuit board via right angle pin connector array 201. The wireless charging loop is located on an opposing side of battery 124 to the circuit board 123.

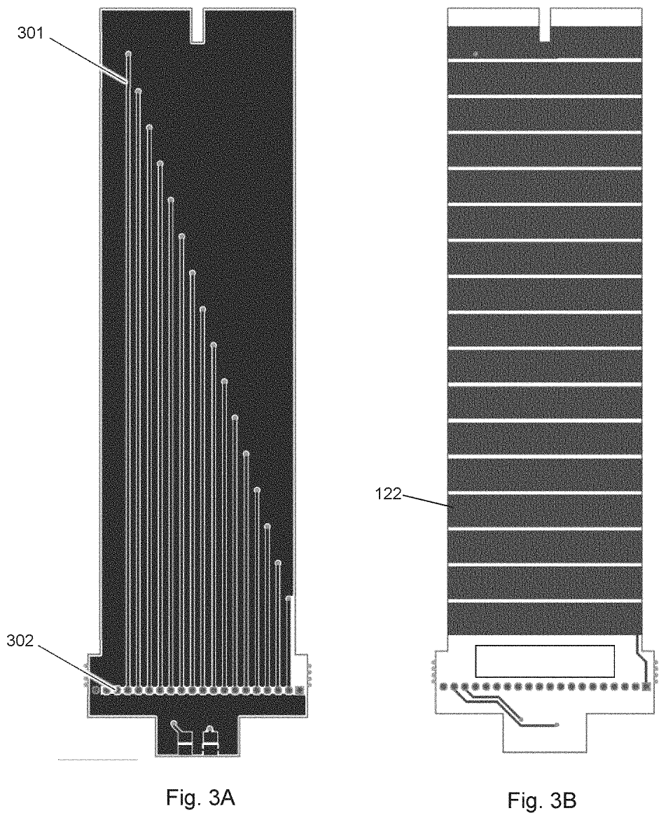

FIGS. 3A and 3B show further detail of the liquid level sensor. FIG. 3A shows a reverse side of the liquid level sensor, in that it is the side which will be furthest from the liquid holding portion and closest to the sidewall of the cup. The reverse side of the liquid level sensor includes a plurality of wire traces 301, which extend from a connector array 302 up the liquid level sensor to respective conductive surfaces. The wire traces 301 connect to vias or through-hole connectors, to electrically contact conductive surfaces 122 located on a front side of the liquid level sensor (in that it is the side which will be closest to the liquid holding portion).

The conductive surfaces of the liquid level sensor may be formed in several ways. For example, the conductive surfaces may be formed from aluminium foil plates, where an aluminium sheet is applied to the sensor and affixed to the surface thereof. As another example, the conductive surfaces may be formed from a copper adhesive tape. As yet another example, the conductive surfaces may be formed from a conductive paint (which may be opaque or transparent) with a surface resistivity on the order of 550 per square metre at 50 microns (as one example). The paint may be applied in the desired configuration directly on the liquid container and may, in some implementations be isolated by a layer of plastic or other insulator to avoid short circuiting the painted plates. As another example, the conductive surfaces may be formed as a flexible or rigid circuit board, where the conductive surface is formed of copper and the dielectric is formed of polyimide.

The liquid level sensor is connected to the circuit board 123, a processor of which (discussed below) calculates the liquid level. The processor utilises the fact that liquids have markedly different dielectric properties to air. For example, the dielectric constant (relative permittivity) of water, εᵣ, is 80.4 at 20° C. Whereas the dielectric constant of air is around 1.013 at the same temperature. The processor has stored, in memory, a reference capacitance value (also referred to a threshold value). The threshold value is empirically derived for any given embodiment. For example, in some embodiments the capacitance value for all sensor elements in the liquid level sensor is recorded when the cup is empty of liquid. The process is then repeated for a cup which is filled (and so all sensor elements are below the liquid level line) for one or more types of liquid (e.g. water, tea, cola). It has been observed that a significant change in capacitance was measured in all cases, between the values taken with an empty cup and the values taken when the cup was filled. Therefore, a single threshold value can be chosen which reliably distinguishes between a sensor element covered by a liquid and a sensor element not covered by a liquid. Typically, the threshold value will be chosen as a value greater than that measured for an empty cup, and lower than the lowest value measured when the cup is filled.

If the measured capacitance for a given conductive surface is below the reference value, the processor marks that this conductive surface is not submerged in liquid. If the measured capacitance for a given surface is above the reference value, the processor marks that this conductive surface is submerged in liquid. Each conductive surface is associated with a certain height from the bed of the liquid holding portion. By finding the conductive surface which is furthest from the bed, and which is also submerged in liquid, allows the processor to gauge the height of liquid within the holding portion. The cross-sectional area of the cup is known a priori to the processor, and so by multiplying the cross-sectional area by the measured height of the liquid, the processor can ascertain the volume of liquid within the cup.

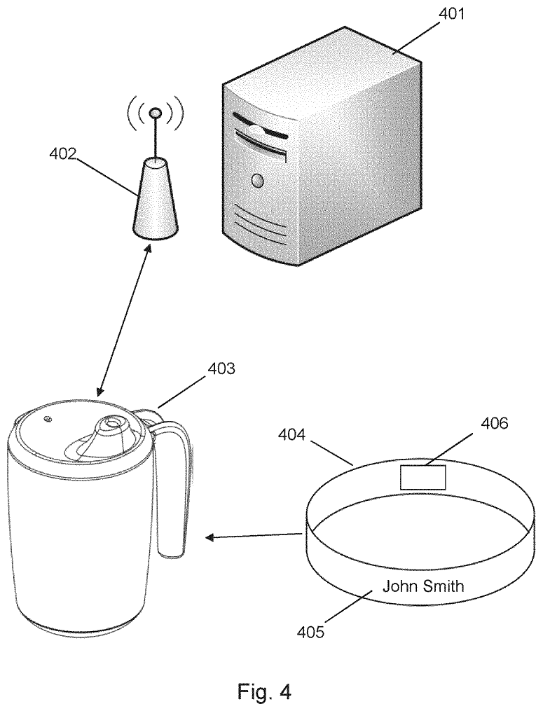

FIG. 4 shows a schematic view of a system according to the present invention. Management computer 401, which may be a Hospital Information System (HIS), is connected to wireless communication point 402. The wireless communication point exchanges information with one or more cups 403, via a respective wireless communication device within the cup. The cup transmits any liquid level changes to the management computer. In some embodiments, this transmission may be via one or more gateway devices of the type discussed previously. That is, the cup may communicate directly with one or more gateway devices, which in turn communicate with the management computer. In addition, the cup is in communication with individual identification wristband 404. The individual identification wristband in this embodiment includes a label 405, and a wireless communication device 406. In some embodiments the individual identification wristband does not include a label. The wireless communication device transmits an identifier of the wristband which may include an identification of the individual. Alternatively, the identifier of the wristband may be individual-agnostic, in that the management computer is aware of individual-band pairings. When the cup takes a liquid level measurement, e.g. in response to the commencement and subsequent cessation of movement of the cup, the cup will also identify the nearest individual identification wristband and will transmit the identification of this wristband together with the new liquid level measurement (or change in liquid level as measured by the cup) to the monument computer 401. The cup may also transmit information such as: battery life; battery charge cycles; time between movement events; extreme movement events (cup being dropped, knocked etc.); inability to connect to any individual identification wrist band; etc.

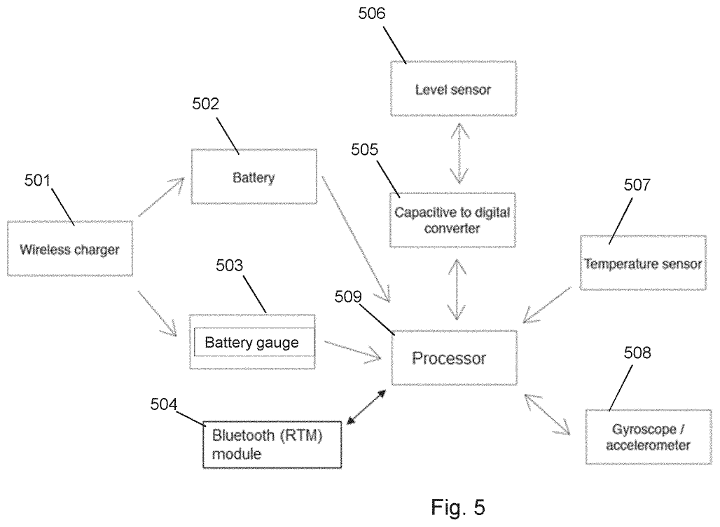

FIG. 5 illustrates the various components which make up the electronics package of the cup 403. A wireless charger 501, is provided (preferably in the base of the cup) and provides power to battery 502. Battery 502 provides power to a Bluetooth® module 504 and battery gauge 503 provides an indication of the battery level to the Bluetooth® module 504. The Bluetooth® module is connected to a capacitive to digital converter 505, which is in turn connected to liquid level sensor 506. In some examples, processor 509 provides the functionality of the capacitive to digital converter 505. The level sensor 506 is as described above, i.e. an array of conductive surfaces. The electronics package may also include a voltage regulator, to maintain a steady voltage supply (e.g. 3.3V) to all components as the battery charge depletes.

Also included is a temperature sensor 507 and gyroscope/accelerometer 508 which are also connected to the Bluetooth® module. The temperature sensor may be used to help identify the nature of the liquid within the cup. The gyroscope/accelerometer 508 may be used to determine when the user of the cup is drinking from the cup, or whether the cup has been knocked over (and so liquid lost may not in fact have been imbibed by the user).

The battery 502, battery gauge 503, Bluetooth® module 504, capacitance to digital converter 505, temperature sensor 507, and gyroscope/accelerometer 508 are connected to processor 509. The processor 509 controls and receives data from the operation of the various components, and calculates the liquid level changes sensed by liquid level sensor 506. The Bluetooth® module 504, battery gauge 503, gyroscope/accelerometer 508, and processor 509 may all be contained within a single printed circuit board.

It will of course be appreciated that the Bluetooth® module may be replaced by another communication means, for example a Wi-Fi® adapter or other data adapter. The cup may be communicatively coupled to a client computing device via a wired and/or wireless connection, and the client computing device may in turn be coupled one or more remote systems over one or more suitable communications networks (e.g., LAN, WAN, Internet, cellular network, USB®, Bluetooth®, Bluetooth® Low Energy, WIFI®, NFC). For example, the client computing device may include a personal computer (e.g., desktop or laptop computer), netbook computer, tablet computer, smart phone, personal digital assistant, wearable computer, etc., associated with the user of the cup 403. The cup 403 may communicate with the management computer 401 by a short-range wireless communications protocol (e.g., Bluetooth®, Bluetooth® Low Energy, WIFI®, NFC), for example. The management computer 401 may be connected to a remote hydration platform system which provides user account management, data storage, public API, and data analysis. The remote hydration platform system may provide third party API support, for example.

The cup may be rechargeable by an external wireless power charger, or may be rechargeable via a wired power charger (for example a USB® cable). The cup may contain one or more replaceable batteries. The cup may include a user interface including one or more inputs (e.g. buttons, touch screen, sensors, and microphone) and one or more outputs (e.g. screen, LED(s), speaker(s), buzzer). The user of the cup may interact with the user interface to thereby interact with the cup. In some embodiments, the user interface may provide information to the user relating to the current volume or historical volume of liquid in the container, and/or may provide notifications to the user. In some examples, the cup may include a minimal or no user interface, and the user may interact with a user interface integrated into a computing device or an interface of another device (e.g. one or more devices connected to the cup). For example, the user may utilize the inputs or outputs of a computing device (for example a smart phone) to interact (for example, receive notifications) with a mobile app executing on the computing device which is connected to the cup. As a further example, the user may utilize the inputs or outputs of a computing device to interact with a cloud terminal or service connected to the cup, using a web interface.

In some implementations, a user may utilize a client computing device to interact with the cup. For example, the client computing device may execute a program or “app” that provides at least one of instructions or data to the cup and receives information from the container via one or more suitable communications interfaces (e.g., NFC, Bluetooth®, Bluetooth® Low Energy, USB®, WIFI®).

The cup may collect and store sensor data from one or more sensors at fixed or variable time intervals. This collection of data forms a collection of time-series data that may be processed to providing information presentable to a user through a user interface, such as a display of one or more of the client computing devices or a light (e.g., LED) on the cup.

The cup may transmit various data or information to the client computing device and/or to a hydration platform system. For example, the cup may from time-to-time transmit a subset of or all of the collected time-series measurement data to the client computing device or to the hydration platform system. In some implementations, the cup may transmit only a subset of the collected time-series data that includes the most recent measurement, or the measurements obtained since the previous successful transmission of the measurement data to the client computing device.

Although not required, some portion of the implementations will be described in the general context of computer-executable instructions or logic, such as program application modules, objects, or macros being executed by a computer. Those skilled in the relevant art will appreciate that the illustrated implementations as well as other implementations can be practiced with other computer system or processor-based device configurations. The implementations can be practiced in distributed computing environments where tasks or modules are performed by remote processing devices, which are linked through a communications network. In a distributed computing environment, program modules may be located in both local and remote memory storage devices.

The cup may include one or more processors (e.g., microcontroller) and non-transitory computer- or processor-readable media, for instance one or more non-volatile memories such as read only memory (ROM), erasable programmable read-only memory (EPROM) or FLASH memory and/or one or more volatile memories such as random access memory (RAM). 5. The microcontroller may be used to store information from all the sensors until it is needed to calculate the volume of the liquid and identify the liquid. The microcontroller may also have a lookup table or artificial neural network that will may take the inputs from the temperature sensor, IR spectrometer and relative permittivity of the liquid contained inside the cup to identify what liquid it is.

As discussed above, the cup also includes one or more sensors or detectors, such as a capacitive sensor, an accelerometer/gyroscope, a temperature sensor, a battery gauge, additional sensors, or any combination thereof. The sensors may be operatively coupled to the one or more processors. The battery gauge may measure the current coming in and out of the battery and so allows tracking of how charged/discharged the battery is. It also allows prediction of how long until full discharge and allow the user to have this information to prevent the device running out of charge whilst in use. This can also keep track of the total number of cycles the battery has been through which can allow an estimation of its end of life.

The cup may include an IR spectrometer, which consists of an emitter and a receiver. By measuring how much IR light passes through and is reflected by the liquid it is possible to calculate the liquids IR properties, which may be used by the processor for liquid identification.

The cup may include one or more communications transceivers and their antennas. For example, the cup may include one or more cellular transceivers, one or more WIFI® transceivers, one or more Bluetooth® transceivers, and one or more Bluetooth® Low Energy transceivers, along with their antennas. The cup may further include one or more wired interfaces that utilize parallel cables or serial cables, for instance, via one or more of Universal Serial Bus (USB®), Thunderbolt®, or Gigabyte Ethernet®, for example.

The cup may include one or more audio/haptic notification modules which may include a speaker, a buzzer (e.g., piezoelectric), a vibrator (e.g., pager motor), etc. The cup may also include one or more visual notification modules which may include one or more lights (e.g., LEDs), one or more displays, etc. For example, the visual notifications module may include multiple colours of LEDs which may be used for notification (e.g., low battery, connection status) and/or feedback (e.g., hydration warning).

The cup may also include an NFC/RFID module.

For instance, an NFC/RFID tag may be readable by the device if the user places it within a certain distance of the device. The NFC tag may be used to identify users or inform the cup when it is being cleaned. The cup may also have its own NFC/RFID tag which may be used to simplify setup and/or may be used in a group data setup scenario where the user may be added to a group by tapping on the tag with the client computing device when prompted by a program executing on the client computing device. Some or all of the components within the cup may be communicably coupled using at least one bus or similar structure adapted to transferring, transporting, or conveying data between the devices, systems, or components used within the cup. The bus can be an I2C (Inter-Integrated Circuit) bus, UART (universal asynchronous receiver-transmitter) bus and/or a SPI (Serial Peripheral Interface) bus.

The processor(s) may include any type of processor adapted to execute one or more machine executable instruction sets, for example a conventional microprocessor, a reduced instruction set computer (RISC) based processor, an application specific integrated circuit (ASIC), digital signal processor (DSP), microcontroller, or similar. Within the processor(s), a non-volatile memory may store all or a portion of a basic input/output system (BIOS), boot sequence, firmware, start-up routine, and communications device operating system executed by the processor upon initial application of power. The processor(s) may also execute one or more sets of logic or one or more machine executable instruction sets loaded from the memory subsequent to the initial application of power to the processor. The processor may also include a system clock, a calendar, or similar time measurement devices.

In at least some implementations, one or more sets of logic or machine executable instructions providing programs executable by the processor may be stored in whole or in part in at least a portion of the memory. In at least some instances, the applications may be downloaded or otherwise acquired by the end user, for example using an online marketplace. In some implementations, such applications may start up in response to selection of a corresponding user selectable icon by the user or consumer. The application can facilitate establishing a data link between the cup and the hydration platform system or the computing device via the transceivers and communication networks.

The one or more processors may control the general purpose inputs and outputs (GPIOs) of the cup, and captures and processes capacitive, temperature, time, motion and position, as discussed below. The one or more processors may store data to and retrieves data from the memory. The one or more processors may also handle communications exchanges with the client computing device via the communications module. In some implementations, the one or more processors may also cause the production of light notifications, sound notifications, and vibration notifications.

The accelerometer/gyroscope may comprise one or more position sensing devices. In some implementations, the accelerometer may comprise a low power 3-axis accelerometer which is coupled to the processor via an I2C interface. The gyroscope may be used to provide information relating to the pitch, roll and yaw of the cup to assist in the determination of the volume of liquid in the container. Additionally, in some implementations, the accelerometer/gyroscope may be used as a trigger for logging the volume of liquid in the container when motion is detected.

The temperature sensor may include one or more of a thermocouple, thermistor, platinum resistance temperature detector (RTD), positive temperature coefficient (PTC) heater/element, blackbody/infrared emissions detector, etc. In some implementations, the temperature sensor is positioned proximate a base of the cup. The temperature sensor may be optionally be used to provide temperature based compensation to the capacitance measurements, and so provide more accurate liquid volume measurements. The temperature sensor may also be used to help identify the liquid in the container (e.g. coffee or tea is more likely to be hot).

As discussed previously, the cup may also include a power source which includes a battery, a wireless charging coil, and a battery charger controller. The battery may be one or more 3.7 V lithium ion polymer (“LiPo”) batteries, one or more 3.6 V lithium ion (“Li-Ion”) batteries or one or more 1.2 V nickel-metal hydride batteries (“NiMH”) for example. The external wireless charging power source may include an inductive charging transmitter which includes a transmitter coil and a power cable (e.g., USB) which may be coupled to an AC power adaptor or a DC power source (e.g., USB port of a computing device).

In some implementations, some of the components of the cup may be embodied in a separate computing device (e.g., client computing device, or remote system). In some implementations, the cup may be an integrated device that includes some or all of the aforementioned components. Further, it should be appreciated that although certain functions are described herein as being implemented in one of the client computing device, the cup, or the hydration platform system, some or all of such functions may be performed by numerous combinations of these devices, or may be performed in a different one or more of the devices than described above. In other words, the functionality described herein may be implemented in a highly distributed manner or may be implemented in a single self-contained device.

The body and sidewalls of the cup may be made of any non-conductive material, for example a ceramic. The dielectric may be made of essentially any dielectric material. For example, the dielectric may be double sided tape, silicon, or polyimide. An antenna of the cup, usable to communication information to the terminal, may be a dipole antenna which extends up a side of the cup opposite to the sensors.

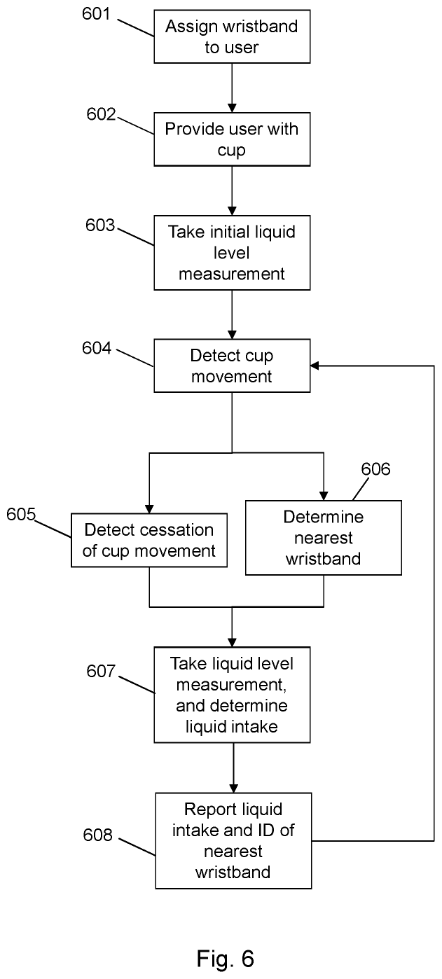

FIG. 6 is a flow diagram illustrating a method of monitoring the liquid level intake of an individual according to the present invention. The method broadly comprises two phases, a setup phase (steps 601-603) and a monitoring phase (604-608. In the setup phase, as a first step 601 an individual identification wristband is assigned to a user or individual. This can be performed, for example, on the management computer or on a terminal in contact with the management computer. Subsequently, in step 602, a cup is provided to the user. Advantageously, there is no requirement to pair the cup with the user and so cups can be distributed without reference to any chart or allocation list. In step 603, an initial liquid level measurement is taken. This step can be performed before or after step 602, in this example it is shown as being subsequent to step 602. The initial liquid level measurement may be triggered by the person distributing the cups to users, or may be triggered by the temperature sensor detecting a change in temperature indicative of a liquid being poured into the cup. This initial liquid level measurement is stored in memory of the processor, so that it can be referenced later in order to determine the amount of liquid consumed by the user.

Step 603 constitutes the end of the setup phase, and after this the method moves to the monitoring phase. The processor waits for the gyroscope/accelerometer to detect cup movement in step 604, which may indicate that the user is about to consume liquid from the cup. After this initial movement is detected, the processor waits until it can detect that movement of the cup has ceased (step 605). In step 606, the processor determines the nearest individual identification wristband. This step can be performed before, simultaneously with, or after, step 605. The determination of the nearest individual identification wristband may be based on a signal strength of all wristbands within communication range of the cup. The processor may list all wristbands in communication with the cup, and select the wristband with the highest signal strength.

After the processor has determined that the cup has ceased movement (in step 605), step 607 is performed in which the liquid level measurement is taken and the liquid intake of the patient is determined. In some examples, the cup may only record the new liquid level measurement, and may transmit this to the management computer which will determine (from the difference between the most recent liquid level measurement and the new liquid level measurement) the amount of liquid consumed by the user. In this example, the cup references the most recent liquid level measurement and the new liquid level measurement in order to determine the amount of liquid consumed.

This value is then reported to the management computer, together with the identification of the nearest wristband. It should be noted, that step 606 could be performed before, simultaneously with, or after, step 607. The only constraint is that the nearest wristband should be determined before step 608.

After step 608, the method returns to step 604 and the processor awaits a further detection that the cup is being moved.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

### LIST OF FEATURES

100 Lid
101 Upper housing
102 Lid connector
103 Mouthpiece
104 Vent hole
110 Central body
111 Sidewall
112 Sensor housing
113 Handle
120 Electronics package
121 Liquid level sensor
122 Conductive surface
123 Circuit board
124 Battery
130 Base
131 Lower housing portion
132 Liquid sensor guides
201 Right angle pin connector array
202 Wireless charging loop
301 Wire trace
302 Connector array
401 Management computer
402 Wireless communication point
403 Cup
404 Individual identification wristband
405 Label
406 Wireless broadcaster
501-509 Electronic components
601-608 Method steps

1. A cup for measuring the liquid intake of an individual, the cup comprising:
a liquid holding portion, defined by at least one sidewall and a base;
a liquid level sensor, comprising a plurality of conductive surfaces disposed in an array along the sidewall in a direction away from the base; and
a processor, configured to derive a liquid level from the liquid level sensor by determining which of the plurality of conductive surfaces have a capacitance higher than a threshold value, the threshold value being indicative of the respective conductive surface being below a liquid level line, and thereby measure the liquid intake of the individual.

2. The cup of claim 1, wherein the cup has a cylindrical axis, and the array of conductive surfaces extend in a direction parallel to the cylindrical axis.

3. The cup of claim 2, wherein each conductive surface of the array projects in a direction perpendicular to the cylindrical axis.

4. The cup of claim 1, further comprising one or more capacitive shields, positioned on an opposing side of the liquid level sensor to the liquid holding portion.

5. The cup of claim 1, wherein the cup includes a battery and wireless charger, and wherein the liquid level sensor, processor, battery, and wireless charger are within a sealed unit.

6. The cup of claim 1, further including an accelerometer, configured to detect movement of the cup, and wherein the processor is configured to derive a liquid level upon cessation of movement of the cup and compare this measurement to a previously made measurement.

7. The cup of claim 1, further including a gyroscope, configured to detect angular motion of the cup, and wherein the processor is configured to prohibit the derivation of a liquid level whilst the cup is not substantially level.

8. The cup of claim 7, wherein the processor is configured to place the cup into a hibernation mode when readings from the gyroscope determine that the cup has been inverted.

9. The cup of claim 1, wherein the liquid level sensor further includes a common electrode, connected in parallel to each of the conductive surfaces.

10. The cup of claim 9, wherein the common electrode is located in the base portion of the liquid holding portion.

11. The cup of claim 1, wherein each conductive surface in the array has substantially identical dimensions.

12. The cup of claim 1, wherein the array includes at least 10 conductive surfaces.

13. The cup of claim 1, further including a temperature sensor, configured to measure the temperature of a liquid when present in the liquid holding portion.

14. The cup of claim 13, wherein the processor is configured to use a capacitance value from one or more of the conductive surfaces and a temperature value measured by the temperature sensor to identify a liquid present in the liquid holding portion.

15. The cup of claim 1, further including a wireless communication module, and the processor is configured to use the wireless communication module to determine a nearest individual identification unit, and to associate the measured liquid intake with the individual corresponding to the nearest individual identification unit.

16. The cup of claim 1, further including a wireless communication module, configured to transmit the measured liquid intake of the individual to a base station.

17. A system for monitoring the liquid intake of an individual, the system comprising:
a cup, according to claim 1, the cup including a wireless communication module and being configured to measure the liquid intake of the individual;
an individual identification unit, configured to wirelessly transmit an individual identification signal to the cup; and
a management computer, configured to receive and record the measured liquid intake and the individual identification signal.

18. The system of claim 17, wherein the management computer is configured to receive and record the measured liquid intake and individual identification signal received from the cup.

19. A method of monitoring a liquid intake of an individual, said method comprising:
providing a cup comprising;
a liquid holding portion, defined by at least one sidewall and a base;
a liquid level sensor, comprising a plurality of conductive surfaces disposed in an array along the sidewall in a direction away from the base; and
a processor, configured to derive a liquid level from the liquid level sensor by determining which of the plurality of conductive surfaces have a capacitance higher than a threshold value, the threshold value being indicative of the respective conductive surface being below a liquid level line; and
monitoring the liquid intake of the individual using the cup.
